(19) United States
(12) Patent Application Publication
(10) Pub. No.: US 2003/0184048 A1
(43) Pub. Date: Oct. 2, 2003

(54) Pivotable receiver hitch utility arm

(76) Inventor: Daryl F. Bonde, Camp Verde, AZ (US)

Correspondence Address: STURM & FIX LLP, 206 SIXTH AVENUE, SUITE 1213, DES MOINES, IA, 50309-4076, US

(21) Appl. No.: 10/114,848

(22) Filed: Apr. 2, 2002

(51) Int. Cl. B60D 1/00

(52) U.S. Cl. 280/491.5

(57) ABSTRACT

A pivotable utility arm 10 for use with a vehicle receiver hitch 101 wherein the utility arm 10 includes a generally vertical support arm unit 12 pivotally connected to a horizontal beam unit 11 adapted to be releasably received in the vehicle receiver hitch 101 and a locking unit 13 that selectively captively engages the support arm unit 12 relative to the beam unit 11 to deploy the utility arm 10 in its operative disposition or releases the support arm unit 12 into a pivoting relationship relative to the beam unit 11 for storage purposes.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of hitch mounted accessory devices in general and in particular to a pivotable and collapsible receiver hitch utility arm.

2. Description of Related Art

As can be seen by reference to the following U.S. Pat. Nos. 5,941,514; 4,490,920; 5,608,970; 5,984,292; and, 4,489,927, the prior art is replete with myriad and diverse hitch mounted accessories.

While all of the aforementioned prior art constructions are more than adequate for the basic purpose and function for which they have been specifically designed, they are uniformly deficient with respect to their failure to provide a simple, efficient, and practical hitch mounted utility arm that has a vertically adjustable pivoted angled support post that can be collapsed onto the main portion of the utility arm to present a very slim storage profile that is not possible to achieve with the above cited patented structures.

As most vehicle owners are aware, they are much more likely to use an automotive accessory if it is easy to install and use and which will occupy very little of the precious cargo space available in their vehicle.

As a consequence of the foregoing situation, there has existed a longstanding need among vehicle owners for a new and improved hitch mounted utility arm that is not only practical and efficient, but which also employs a novel pivot locking arrangement that allows the utility arm to assume a very slim collapsed storage profile; and the provision of such an arrangement is a stated objective of the present invention.

### BRIEF SUMMARY OF THE INVENTION

Briefly stated, the receiver hitch utility arm that forms the basis of the present invention comprises in general a support beam unit, a vertically adjustable support arm unit and a pivoted locking unit wherein the support arm unit is further pivotally secured to the beam unit and releasably secured thereto in its operative mode via the pivotal locking unit.

As will be explained in greater detail further on in the specification, the beam unit includes an elongated beam member having an inboard end adapted to be releasably received in a vehicle hitch receptacle and an outboard end affixed to the lower hinge plate element of a hinge member.

In addition, the support arm unit includes a generally vertical support arm member having a lower angled segment fixedly secured to the upper hinge plate element of the hinge member to form the operative connection between the support arm member and the beam member.

Furthermore, the locking unit includes an elongated threaded shaft pivotally suspended from the upper hinge plate element and adapted to be received in a vertical groove in the beam member such that a locking nut can captively engage the hinge member in the closed position to deploy the support arm member in its operative disposition relative to the beam member.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the utility arm of this invention installed in a conventional vehicle hitch receptacle;

FIG. 2 is a side elevation view of the arrangement depicted in FIG. 1;

FIG. 3 is an enlarged detail view of the telescoping portion of the arm unit;

FIG. 4 is an enlarged detail view of the operative engagement between the hitch receptacle and the inboard end of the beam unit;

FIG. 5 is a perspective view of the arm unit pivoted out of engagement with the beam unit;

FIG. 6 is a perspective view of the arm unit engaging the beam unit prior to the locking unit being engaged;

FIG. 7 is a perspective view of the arm unit engaging the beam unit with the locking unit being fully engaged;

FIG. 8 is a cross-sectional view taken through line 8-8 of FIG. 7;

FIG. 9 is a perspective view showing the arm unit fully deployed relative to the beam unit;

FIG. 10 is a perspective view of the arm unit folded into its collapsed mode relative to the beam unit; and, FIG. 11 is a perspective view of an extended load support accessory contemplated for use with the utility arm of this invention.

### DETAILED DESCRIPTION OF THE INVENTION

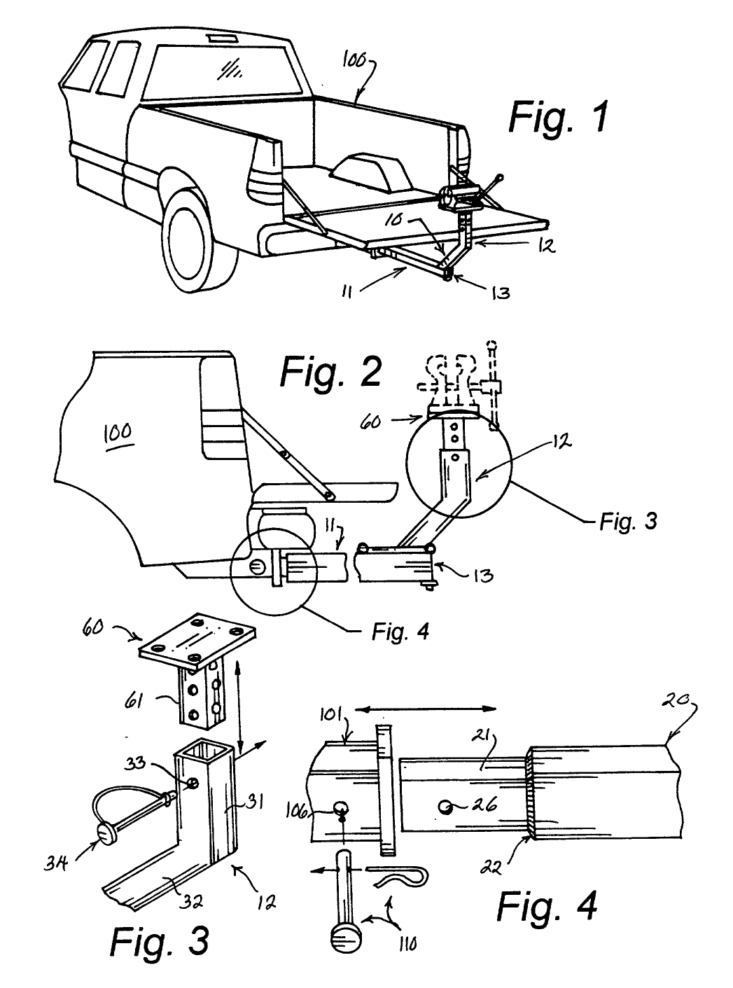

As can be seen by reference to the drawings, and in particularly to FIGS. 1 and 2, the pivotable utility arm for receiver hitches that forms the basis of the present invention is designated generally by the reference number 10. The utility arm 10 comprises in general a beam unit 11, a support arm unit 12, and a pivoted locking unit 13. These units will now be described in seriatim fashion.

As shown in FIGS. 4 through 9, the beam unit 11 comprises an elongated hollow rectangular horizontal beam member 20 having a generally square male adapter element 21 formed on its inboard end 22 and a face plate 23 provided with a vertical groove 24 formed on its outboard end 25.

As can best be seen by reference to FIG. 4, the male adapter element 21 is dimensioned to be received in a conventional vehicle hitch receptacle 101 wherein the male adapter element 21 is further provided with aligned apertures 26 that are adapted to be aligned with complementary apertures 106 in the hitch receptacle 101 such that a cotter pin arrangement 110 can be employed to releasably secure the beam member 20 to the frame of a vehicle 100 in a well recognized manner.

Turning now to FIGS. 2, 3, 9, and 10, it can be seen that the support arm unit 12 comprises an angled support arm member 30 having a hollow vertical upper segment 31 and an angled lower segment 32 which is operatively connected to the horizontal beam member 20 by a hinge plate 40 which will be described in greater detail further on in the specification.

As shown in FIGS. 2, 3, and 9, the hollow vertical upper segment 31 is provided with one or more pairs of opposed mounting apertures 33 and the hollow interior of the vertical upper segment 31 is dimensioned to receive the apertured shaft 61 of an appliance head 60 such as the support plate illustrated in FIG. 3 or the T-bar illustrated in FIG. 11 as part of the load support accessory 60 mentioned previously which is further adapted to receive extension arm elements 62; wherein locking pin elements 34 may be employed in a well recognized manner to secure any one of the accessory elements 60 to the vertical upper segment 31 of the support arm member 30 in a variety of orientations and vertical heights to match the height of the truck tailgate.

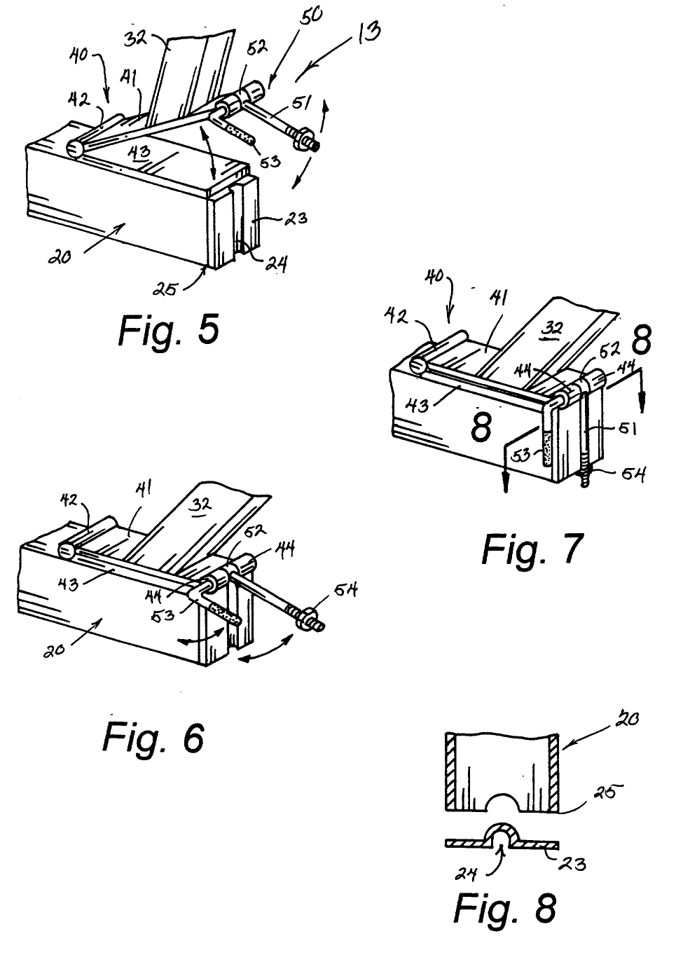

As can best be appreciated by reference to FIGS. 5 through 7, the hinge plate 40 comprises an upper hinge plate element 41 fixedly secured to the bottom of the angled lower segment 32 of the support arm member 30 and operatively connected by a pivot element 42 to a lower hinge plate element 43 which is fixedly secured to the top of the outboard portion of the beam member 20.

In addition, the locking unit 13 is operativley associated with the hinge plate 40 and comprises a generally T-shaped locking member 50 having an elongated threaded shaft element 51 suspended from a pivot rod cross-bar 52 and provided with an actuator handle 53; wherein, the threaded shaft element 51 is dimensioned to be received in the vertical groove 24 in the face plate 23 and to be secured therein by a locking nut 54; and, wherein the pivot rod cross-bar 52 is dimensioned to be rotatably received in a pair of barrel eyelets 44 formed on the outboard end of the upper hinge plate element 41.

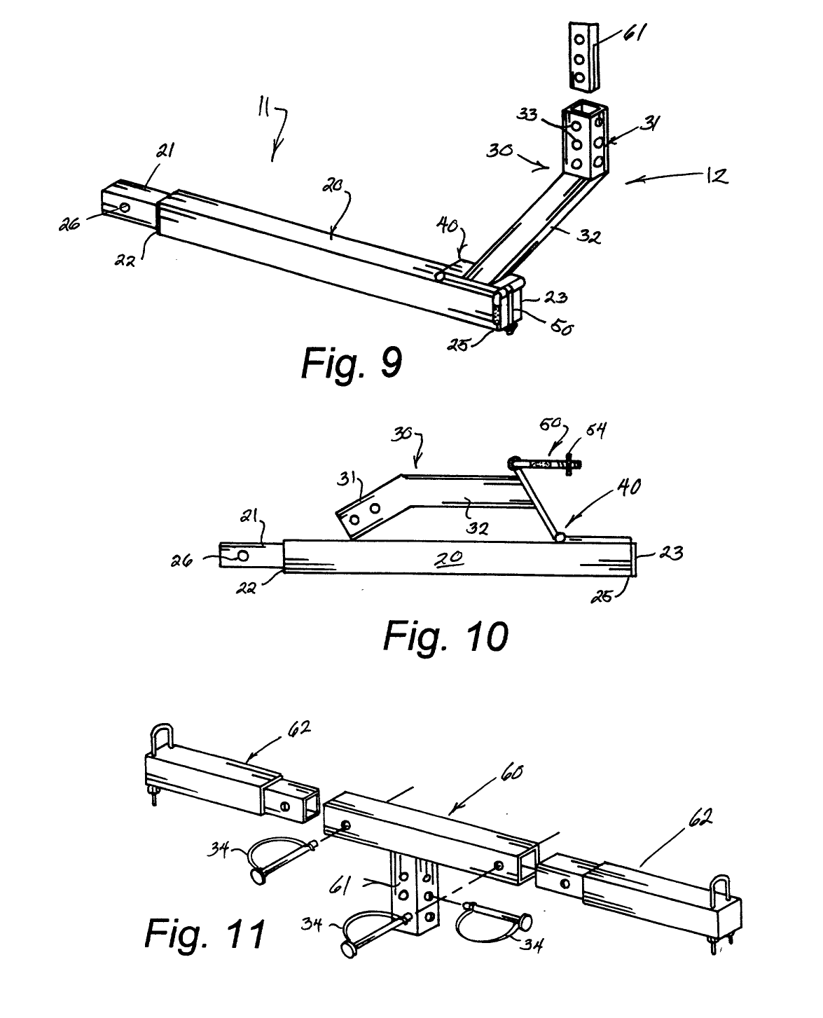

As can best be appreciated by reference to FIGS. 9 and 10, when the vertical support arm member 30 is in its operative disposition relative to the horizontal beam member 20, the threaded shaft 51 is maintained in the groove 24 in the face plate 23 of the beam member 20 by the engagement of the locking nut 54 with the bottom of the beam member 20.

Then when the vertical support arm 30 needs to be collapsed into its storage mode, the locking nut 54 is loosened to allow the threaded shaft 51 of the locking member 50 to be pivoted out of engagement with the vertical groove 24 so that the upper hinge plate element 41 may be pivoted away from the lower hinge plate element 43 in a well recognized fashion.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A pivotable utility arm for use with the female receptacle of a vehicle receiver hitch wherein the utility arm comprises:
a beam unit including an elongated generally rectangular beam member having an outboard end and an inboard end; the inboard end is adapted to be captively yet releasably received in the vehicle receiver hitch; and,
a support arm unit including an angled support arm member having an upper vertical segment and a lower angled segment wherein the upper segment is adapted to releasably receive a variety of diverse accessory members and wherein the lower segment is pivotally connected to the outboard end of the beam member.

2. The utility arm as in claim 1 further comprising:
locking means for captively engaging the support arm member relative to the beam member.

3. The utility arm as in claim 2; further comprising:
a pivot member including an upper hinge plate element fixedly secured to the angled lower segment of the support arm member and a lower hinge plate element fixedly secured to the outboard end of the beam member wherein the upper and lower hinge plate elements are connected to one another by a pivot rod.

4. The utility arm as in claim 3; wherein, the outboard end of the beam member is further provided with a face plate having a vertical groove adapted to receive a portion of the locking means,

5. The utility arm as in claim 3; wherein, the locking means comprises at least in part:
a threaded shaft associated with the hinge member and having a locking nut adapted to maintain the hinge member in a closed position.

6. The utility arm as in claim 4; wherein, the locking means comprises at least in part:
an elongated threaded shaft pivotally associated with the outboard end of the upper hinge plate element and dimensioned to be received in the vertical groove in the face plate on the outboard end of the beam member, and a locking nut engageable with both the threaded shaft and the bottom of the beam member.

7. The utility arm as in claim 6; wherein, the elongated threaded shaft is suspended from a pivot rod cross-bar that is rotatably supported on one end of the upper hinge plate element.

8. The utility arm as in claim 7; wherein, said pivot rod cross-bar has one end provided with an actuator handle.
